(19) United States
(12) Patent Application Publication
(10) Pub. No.: US 2008/0034994 A1
(43) Pub. Date: Feb. 14, 2008

(54) Bearerless web printing press

(75) Inventor: John Dowling, Rollinsford, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/879,929

(22) Filed: Jul. 19, 2007

Related U.S. Application Data
(60) Provisional application No. 60/831,822, filed on Jul. 19, 2006.

(51) Int. Cl. B41F 7/04

(52) U.S. Cl. 101/217

(57) ABSTRACT

A web offset printing press for printing a web is provided including a bearerless plate cylinder having a plate cylinder gap for receiving a printing plate; a bearerless blanket cylinder having a blanket cylinder gap for receiving a blanket; a first reference ring located on a plate cylinder axial end; and a second reference ring located on a blanket cylinder axial end.

This claims the benefit of U.S. Provisional Application No. 60/831,822 filed Jul. 19, 2006 hereby incorporated by reference herein.

### BACKGROUND

The present invention relates generally to printing presses and more particularly to printing presses having blanket and plate cylinders that are not supported by bearers.

U.S. Pat. No. 4,643,090 discloses a printing press including a method and apparatus for moving printing cylinders between thrown off positions in which bearers connected with the cylinders are separated and thrown on or printing positions.

Helmut Kipphan, in the Handbook of Print Media, discloses that cylinder bearers are used to minimize vibration. Cylinder bearers made from hardened steel with high rolling strength are inserted on the sides of the plate and blanket cylinders to minimize the effect of vibration. The initial tension of cylinder bearers is approximately 15000 N on presses for the 28 inch×40 inch printing format. The basic task of the cylinder bearers is to prevent the rotational vibrations that would normally be generated between the cylinder and gears.

### SUMMARY OF THE INVENTION

The present invention provides a web printing press having a print unit with a narrow gapped plate cylinder and a narrow gapped blanket cylinder. Due to the narrow gaps, bearers can be eliminated.

The present invention provides a web offset printing press for printing a web including:

a bearerless plate cylinder having a plate cylinder gap for receiving a printing plate;

a bearerless blanket cylinder having a blanket cylinder gap for receiving a blanket;

a first reference ring located on a plate cylinder axial end; and

a second reference ring located on a blanket cylinder axial end.

The present invention also provides a web offset printing press for printing a web comprising:

a plate cylinder having a plate cylinder gap for receiving a printing plate; and

a blanket cylinder having a blanket cylinder gap for receiving a blanket;

wherein the plate cylinder gap and blanket cylinder gap are less than or equal to 0.714% of a circumference of the plate cylinder or blanket cylinder respectively.

### BRIEF DESCRIPTION OF THE DRAWINGS

A preferred embodiment of the present invention will be elucidated with reference to the drawings, in which:

FIG. 1 shows a printing press according to the present invention;

FIG. 2 shows a printing unit of the printing press in FIG. 1;

FIG. 3 shows pivoting cylinder boxes of the printing unit in FIG. 2;

FIG. 4 shows a motor driving a blanket cylinder of the printing unit;

FIG. 5 shows reference rings and a gage for the printing unit;

FIG. 6 shows a plate for a plate cylinder of the printing unit; and

FIG. 7 shows diameters of the plate and blanket cylinders in the printing unit.

### DETAILED DESCRIPTION OF A PREFERRED EMBODIMENT

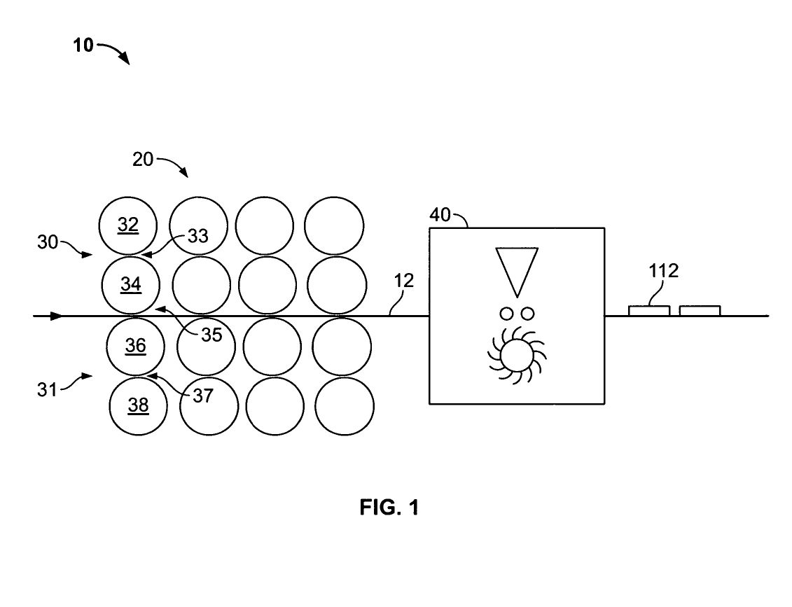

FIG. 1 shows a preferred embodiment of a web printing press according to the present invention. Printing press 10 includes, for example, four printing units 20. Each printing unit 20 includes an upper print couple 30 and a lower print couple 31. Upper print couple includes a plate cylinder 32 and a blanket cylinder 34, while lower print couple 31 includes a blanket cylinder 36 and a plate cylinder 38. A nip 33 is formed between plate cylinder 32 and blanket cylinder 34. A nip 35 is formed between blanket cylinders 34 and 36. A nip 37 is formed between blanket cylinder 36 and plate cylinder 38. A web 12 is printed on by printing units 20 and further processed by folder 40 into printed products 112.

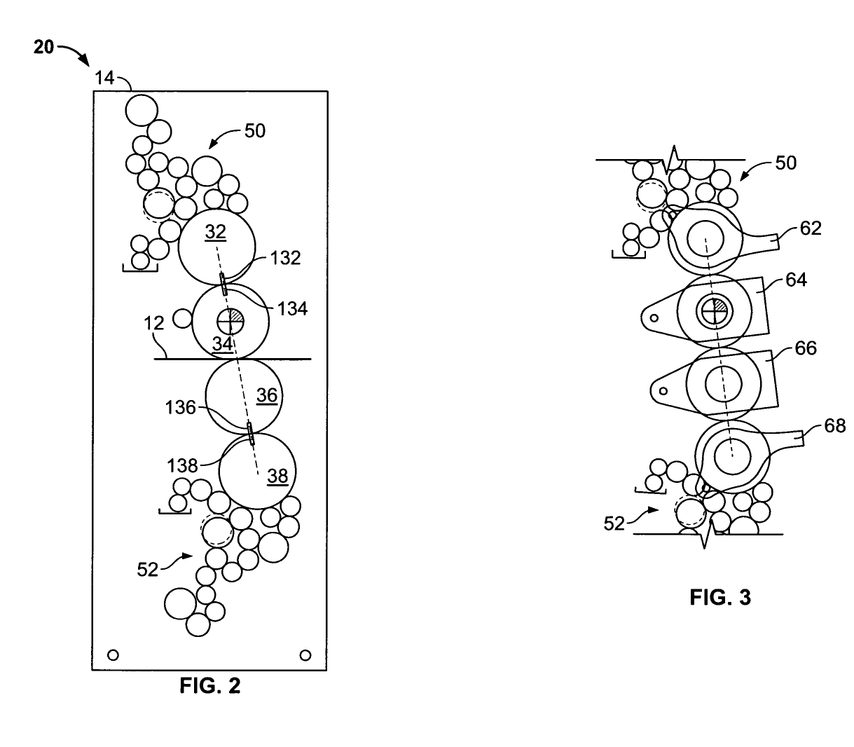

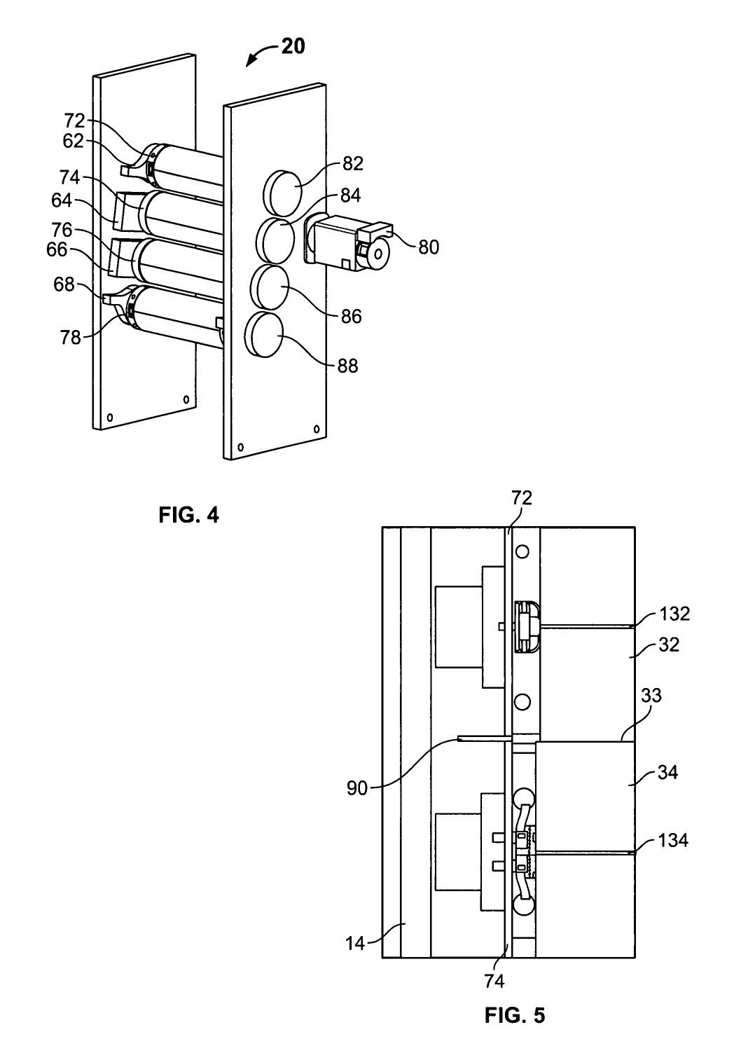

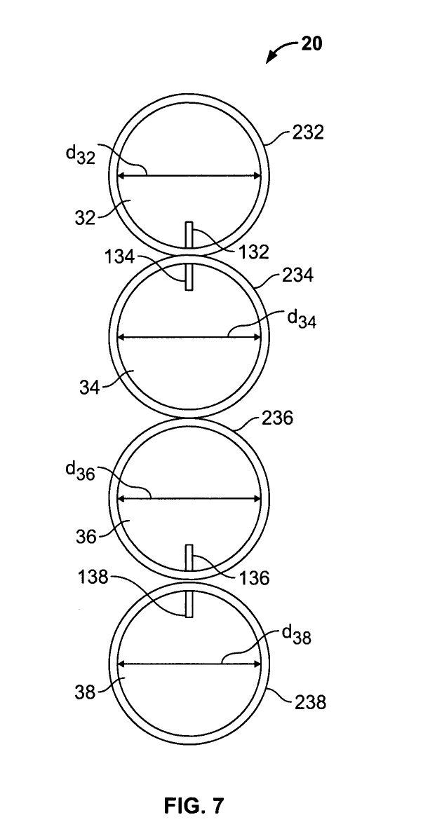

FIG. 2 shows plate cylinders 32, 38 including a narrow gap 132, 138, respectively for locking up plates 232, 238 (FIG. 7) on the surface of plate cylinders 32, 38. Also, blanket cylinders 34, 36 include a narrow gap 134, 136, respectively, for locking up blankets 234, 236 (FIG. 7) on the surface of blanket cylinders 34, 36. Narrow gaps are preferably less than 0.250 inches. Inking units 50, 52 supply inks to plate cylinders 32, 38 respectively. Cylinders 32, 34, 36, 38 are connected to frame 14 via pivoting cylinder supports 62, 64, 66, 68 shown in FIGS. 3 and 4.

Pivoting cylinder supports 62, 64, 66, 68 allow for plate changes while web 12 remains in place. For example, pivoting cylinder supports 62, 64, 66, 68 pivot in such a way to separate plate cylinder 32 from blanket cylinder 34 and plate cylinder 38 from blanket cylinder 36 for plate-changing. Furthermore, pivoting cylinder supports 62, 64, 66, 68 can rotate in such a way to also separate blanket cylinder 34 from blanket cylinder 36, for example, for blanket-changing. Thus, leaving blanket cylinders 34, 36 “thrown off” of web 12. Pivoting cylinder supports 62, 64, 66, 68 can rotate in such a way to separate plate cylinder 32 from blanket cylinder 34, blanket cylinder 34 from blanket cylinder 36, and blanket cylinder 36 from plate cylinder 38.

Narrow gaps 132, 134, 136, 138 can minimize vibration and eliminate the need for bearers typically used to support cylinders 32, 34, 36, 38. By eliminating the need for bearers, plate and blanket cylinders 32, 38, 34, 36 can be sized to achieve optimal plate-to-blanket nip torque and distortion free final print length.

A motor 80 may drive blanket cylinder 34 and other cylinders 32, 36, 38 via gearing. Each cylinder 32, 34, 36, 38 includes a gear 82, 84, 86, 88, respectively. Other variations including multiple motors may be used, for example, blanket cylinders 34, 36 may be independently driven, alternatively, for example, each cylinder 32, 34, 36, 38 may be independently driven.

FIG. 5 shows reference rings 72, 74 for plate cylinder 32 and blanket cylinder 34. A gage 90 is located in between reference rings 72, 74 at nip 33. Each cylinder 32, 34, 36, 38 includes a reference ring 72, 74, 76, 78 and each nip 33, 35, 37 (FIG. 1) includes a gage 90. Reference rings 72, 74 include a space between each other. Gage 90 can be inserted in between reference rings 72, 74. Preferably, the loading between reference rings 72, 74 and gage 90 is minimal, for example, preferably less than 100 N. Gages 90 may be used to make independent plate to blanket and blanket to blanket squeeze adjustments. The reference rings 72, 74, 76, 78 and gages 90 can be made of, for example, steel.

Preferably, print unit 20 (FIG. 2) is a so-called 4×4 commercial print unit, with at least one of the plate and blanket cylinders 32, 34, 36, 38 (FIG. 2) preferably at least 35 inches in circumference, for example, 45.5 inches. This double circumference configuration along with narrow gaps 132, 134, 136, 138 (FIG. 2) for the printing plate and blanket edges held by plate and blanket lock-up mechanisms can help minimize vibrations and may permit the elimination of bearers. The size of gaps 132, 134, 136, 138 (FIGS. 2 and 7) is preferably less than or equal to 0.714% of the circumference of cylinders 32, 34, 36, 38 respectively. The circumference of cylinders 32, 34, 36, 38 can be measured or calculated from the diameters of cylinders 32, 34, 36, 38 (FIG. 7).

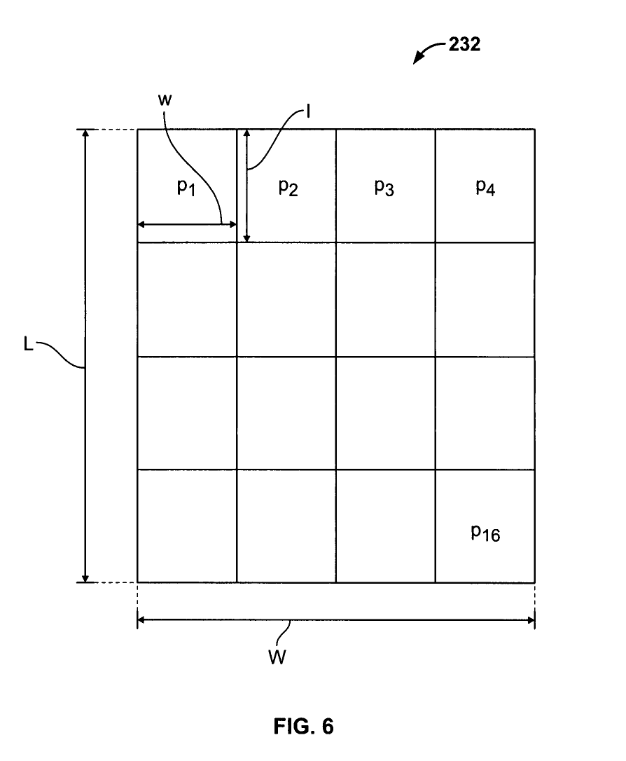

FIG. 6 shows a flat, unmounted plate 232 with pages p₁, p₂, p₃, p₄, etc. Plate 32 may have a width W, for example, 40 inches, and a length L, for example, 45.5 inches. Each page has a width w, nominally 10 inches wide (40/10), for example, and a length l, nominally 11.375 inches long (45.5/4), for example. The preferred print unit is generically referred to as a 4 page across, 4 page around, long grain format, ergo 4×4. The plate and blanket cylinders are, for example, nominally 45.5 inches around.

Owing to the lack of bearers, the plate and blanket cylinders 32, 34, 36, 38 (FIG. 7) can be strategically sized to achieve optimal plate-to-blanket nip torque and distortion free final print length. A diameter d₃₂, d₃₄, d₃₆, d₃₈ of the plate and blanket cylinders 32, 34, 36, 38 with plates 232, 238 and blankets 234, 236 mounted thereon preferably is such that a plate diameter d₃₂, d₃₈ is greater than a blanket diameter d₃₄, d₃₆, for example, d₃₂>d₃₄, and the exact ratio of diameters can be determined through specialized calculations and experimental verifications based on various quantities such as width, types of blanket materials used, etc. to optimize the nip torque and distortion free final print length.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A web offset printing press for printing a web comprising:
a bearerless plate cylinder having a plate cylinder gap for receiving a printing plate;
a bearerless blanket cylinder having a blanket cylinder gap for receiving a blanket;
a first reference ring located on a plate cylinder axial end; and
a second reference ring located on a blanket cylinder axial end.

2. The web offset printing press as recited in claim 1 further comprising a gage between the first and second reference rings for recording the squeeze pressure.

3. The web offset printing press as recited in claim 1 wherein the blanket is rubber.

4. The web offset printing press as recited in claim 1 wherein the plate cylinder gap is about 0.250 inches wide or less.

5. The web offset printing press as recited in claim 1 wherein the blanket cylinder gap is about 0.250 inches wide or less.

6. The web offset printing press as recited in claim 1 wherein the plate cylinder gap is less than or equal to 0.714% of a circumference of the plate cylinder.

7. The web offset printing press as recited in claim 1 wherein the blanket cylinder gap is less than or equal to 0.714% of a circumference of the blanket cylinder.

8. The web offset printing press as recited in claim 1 wherein the plate cylinder has a diameter greater than a diameter of the blanket cylinder.

9. The web offset printing press as recited in claim 1 wherein a circumference of the plate or blanket cylinder is at least 35 inches.

10. The web offset printing press as recited in claim 9 wherein a circumference of the plate or blanket cylinder is 45.5 inches.

11. The web offset printing press as recited in claim 1 further comprising pivoting cylinder supports for supporting the plate and blanket cylinders.

12. The web offset printing press as recited in claim 1 further comprising a motor and gears for driving the plate and blanket cylinders.

13. A web offset printing press for printing a web comprising:
a plate cylinder having a plate cylinder gap for receiving a printing plate; and
a blanket cylinder having a blanket cylinder gap for receiving a blanket;
wherein the plate cylinder gap and blanket cylinder gap are less than or equal to 0.714% of a circumference of the plate cylinder or blanket cylinder respectively.

14. The web offset printing press as recited in claim 13 wherein the plate cylinder gap is about 0.250 inches wide or less.

15. The web offset printing press as recited in claim 13 wherein the blanket cylinder gap is about 0.250 inches wide or less.
